(19) United States
(12) Patent Application Publication
(10) Pub. No.: US 2013/0186813 A1
(43) Pub. Date: Jul. 25, 2013

(54) COOKING-OIL DEGRADATION PREVENTER AND COOKING-OIL DEGRADATION PREVENTION METHOD

(71) Applicant: Isao Aruse, Yamagata-shi (JP)

(72) Inventor: Isao Aruse, Yamagata-shi (JP)

(73) Assignee: ARUSE ECO KAIHATU CO., LTD., Yamagata (JP)

(21) Appl. No.: 13/637,317

(22) PCT Filed: Mar. 23, 2011
(86) PCT No.: PCT/JP2011/056980

§ 371 Date: Oct. 25, 2012

(30) Foreign Application Priority Data
Mar. 25, 2010 (JP) 2010-070117

(51) Int. Cl. A47J 37/12

(52) U.S. Cl. CPC A47J 37/1223
USPC 210/167.28

(57) ABSTRACT

A titanium plate including a titanium oxide coating obtained by anodizing a titanium steel is arranged in a protection member through which a cooking oil can flow into an inner space of the protection member, in such a manner that most of front and back surfaces of the titanium plate is spaced out from an inner surface of the protection member so as to be able to come into contact with a cooking oil during cooking. High temperature cooking with a cooking oil kept in contact with the titanium plate including the titanium oxide coating obtained by anodizing the titanium steel elongates the life span of the cooking oil and improves the textures of cooked foods.

### TECHNICAL FIELD

The present invention relates to a cooking-oil degradation preventer and a cooking-oil degradation prevention method which are capable of preventing degradation of a cooking oil by use of a titanium plate including a titanium oxide coating that is obtained by anodizing a titanium steel and is useful as a photocatalyst, a photoelectric conversion element, or the like.

### BACKGROUND ART

When a cooking oil such as a tempura oil or frying oil is used for a long time at a high temperature, the cooking oil is degraded due to the oxidization. This increases the viscosity and adhesiveness of the cooking oil to soil a heat-cooking vessel or promotes coloration and bad smelling of the cooking oil. As a result, there arise problems such as degrading the quality of cooked deep-fried foods and lowering a brittle texture of the deep-fried foods.

In order to solve these problems, it has been common practice to filter a degraded cooking oil through a filter or the like to reuse the cooking oil, and special cooking oil filters have been developed (for example, see Patent Document 1).

However, the filtering with a filter or the like does not directly retard the degradation of the cooking oil, or cannot prevent harmful substances from adhering to an inner surface of a heat-cooking vessel as cookware.

In contrast, Patent Document 2 discloses the invention in which an inner surface of a fryer inner case is coated with a catalyst for preventing cooking-oil degradation. Thanks to the action of the cooking-oil degradation catalyst, use of such an inner case makes it possible to prevent the degradation of a cooking oil, prevent an increase in the viscosity of the cooking oil and elongate the life span of the cooking oil. In addition, it is explained that the use of such an inner case enables cooking of flavorous and crispy deep-fried foods by inhibiting oil penetration. Moreover, according to the fryer inner case described in Patent Document 2, a reforming catalyst containing silver and a photocatalyst made of titanium or a titanium alloy are described as examples of the catalyst for degradation prevention.

The direct coating on the fryer inner case, however, has problems such as complicated manufacturing processes and a remarkable rise of the price. Additionally, a material for a fryer inner case needs to be selected from materials suitable for the coating. Hence, the fryer inner case has a problem of limitation of the selection range as a cooking vessel made in consideration of not only attainment of nonstick properties, heat conductivity and heat retaining properties under severe cooking conditions at a high temperature, but also excellence in design, for example.

Under such circumstances, studies have been vigorously made on a method of manufacturing an anatase titanium oxide coating in recent years. For example, Patent Document 3 proposes a method of manufacturing an anatase titanium oxide coating including the steps of: (i) forming a titanium nitride in a surface of titanium or a titanium alloy; and (ii) immersing the titanium or titanium alloy obtained in the step (i) in an electrolytic solution containing at least one kind of acid selected from the group consisting of inorganic acids having etching effects on titanium and organic acids having the effects, and anodizing the titanium or titanium alloy with application of a voltage equal to or higher than a sparkover voltage.

With this manufacturing method, it is possible to manufacture an anatase titanium oxide coating that is suitable for industrial production, and is also excellent in properties such as photocatalyst activity due to containing of a large amount of anatase titanium oxide formed therein.

### RELATED ART DOCUMENT

### Patent Document

Patent Document 1: Japanese Patent Application Publication No. Hei 9-19612

### Patent Document 2: Japanese Patent Application Publication No. 2008-161309

### Patent Document 3: Japanese Patent No. 3858058

### DISCLOSURE OF THE INVENTION

An objective of the present invention is to provide a cooking-oil degradation preventer and a cooking-oil degradation prevention method which are capable of preventing degradation of a cooking oil through inexpensive and simple treatment without using direct coating on a fryer inner case.

In order to achieve the above objective, a cooking-oil degradation preventer according to an example of the present invention includes a titanium plate to be accommodated in a pot, and this titanium plate is positioned to be in contact with a cooking oil filled in the pot and includes a titanium oxide coating obtained by anodizing a titanium steel. The titanium plate includes multiple openings provided to pass through the titanium plate in its thickness direction. These openings have a function to fall down tempura scraps in the cooking oil above the titanium plate to below the titanium plate through the openings.

### BRIEF DESCRIPTION OF THE DRAWINGS

FIG. 1 is a diagram showing elapsed time and degrees of acid value increase in a result of a cooking oil heating test.

FIG. 2 is a diagram showing elapsed time and a change in viscosity increasing rate (%) in the result of the cooking oil heating test.

FIG. 3 is a diagram showing elapsed time and degrees of acid value increase in a result of a frying test.

FIG. 4 is a diagram showing a relationship between elapsed time and an amount of adhered polymers (%) in the result of the frying test.

FIG. 5 is a diagram showing a relationship between elapsed time and an amount of generated foam (%) in the result of the frying test.

FIG. 6 is a diagram showing a relationship between elapsed time and a coloration degree as color comparison between frying oils in a result of a frying test.

FIG. 7 is a perspective view illustrating an example of a cooking-oil degradation preventer according to the present invention.

FIG. 8 is a side view for explaining a configuration of the cooking-oil degradation preventer illustrated in FIG. 7.

FIG. 9 is a view for explaining a modified example for fixation of a titanium plate in a cooking-oil degradation preventer according to the present invention.

FIG. 10 is a perspective view illustrating another example of a cooking-oil degradation preventer according to the present invention.

FIG. 11 is a perspective view illustrating still another example of a cooking-oil degradation preventer according to the present invention.

FIG. 12 is a perspective view of a modified example for fixation of titanium plates in a cooking-oil degradation preventer according to the present invention, in which a protection plate located on the upper side is removed.

FIG. 13 is a plan view for explaining the configuration for the fixation of the titanium plates in the cooking-oil degradation preventer illustrated in FIG. 12.

FIG. 14 is a cross sectional view illustrating a positional relationship among openings provided to protection plates and an opening provided to a titanium plate in a cooking-oil degradation preventer according to the present invention.

FIG. 15 is a cross sectional view illustrating an example of a use condition of a cooking-oil degradation preventer according to the present invention.

FIG. 16 is a cross sectional view illustrating another example of a use condition of a cooking-oil degradation preventer according to the present invention.

### MODES FOR CARRYING OUT THE INVENTION

Hereinafter, preferred examples for carrying out embodiments of the present invention will be described in detail with reference to the accompanying drawings.

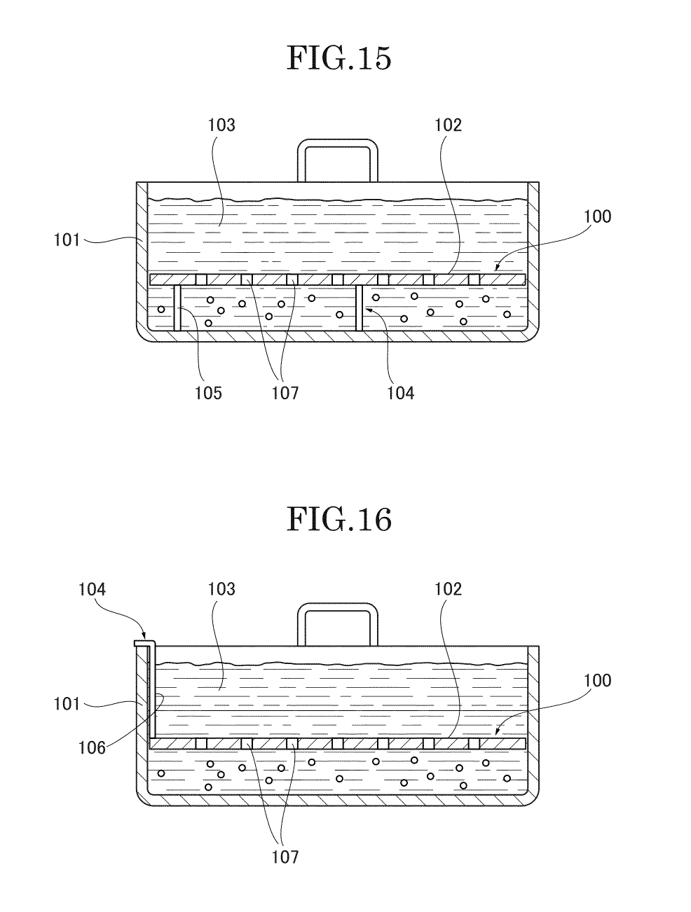

With reference to FIG. 15, one example of a cooking-oil degradation preventer 100 according to the present invention is illustrated. In this example, this cooking-oil degradation preventer 100 has a function to prevent degradation of, for example, a tempura cooking oil, during deep-frying of tempura and thereby to enable the cooking oil to be kept at an initial fresh state over a long period of time. The cooking-oil degradation preventer 100 includes a titanium plate 102 to be accommodated in a pot 101. This titanium plate 102 is positioned by a positioning mechanism 104 to be always in contact with a cooking oil 103 filled in the pot. This positioning mechanism 104 includes multiple leg portions 105 formed on a lower surface of the titanium plate 102, for example. When being placed inside the pot 101, the titanium plate 102 is arranged above the bottom of the pot at an appropriate height level maintained by the leg portions. The positioning mechanism 104 is not limited to the above structure, but may be formed into a structure of an arm 16 having a lower end portion fixed to the titanium plate 102 and an upper end portion to be hooked to an upper edge of the pot, as illustrated in FIG. 16. The titanium plate 102 is fixed to the pot for the time being with the upper end portion of the arm hooked on the upper edge of the pot. Such positioning mechanism 104 is configured to position the titanium plate 102 in the pot 101 so that the titanium plate 102 can be always in contact with the cooking oil 103 filled in the pot. Incidentally, it is preferable that the leg portions or the arm be configured to be foldable when not in use.

The titanium plate 102 includes multiple openings 107. These openings 107 are provided in the titanium plate to pass through the titanium plate 102 in its thickness direction. When tempura is deep-fried, for example, tempura scraps inside the cooking oil above the titanium plate fall down to below the titanium plate through the openings 107. The tempura scarps fall along with convection motions of the cooking oil in up-and-down directions. Thus, impure substances such as tempura scraps or batter pieces stay only for a short time in the cooking oil during the deep-frying of tempura, and therefore the cooking oil during the deep-frying of tempura can be always kept at a fresh state.

The titanium plate 102 includes a titanium oxide coating obtained by anodizing a titanium steel. The titanium plate including a titanium plate containing an anatase titanium oxide coating (titanium oxide coating obtained by anodizing a titanium steel) can significantly elongate the life span of the cooking oil.

To put it differently, it was confirmed that the use of a titanium plate including a titanium oxide coating obtained by anodizing a titanium steel enables suppression of an increase in the acid value, coloration prevention, suppression of bad smelling, and suppression of an increase in the viscosity for a cooking oil, and, besides the above effects, also increases crunchy and brittle textures of a fry cooked as a deep-fried food in a food texture test.

In addition, the safety of this material was examined at Japan Food Research Laboratories. According to the certificate of analysis thus obtained, it was confirmed that the material satisfies the standards and criteria for food and therefore the safety of the component part is secured. Consequently, this titanium plate including the anatase titanium coating was confirmed to be a material suitable to improve the life span of a cooking oil such as a tempura oil under cooking conditions, and to improve the quality of deep-fried foods.

Moreover, this titanium plate is formed as a small piece. In this case, the titanium plate can be put into a cooking oil during cooking irrespective of the type, shape and size of a heat-cooking vessel, and thereby can come into contact with the cooking oil exposed to a high temperature during the cooking. Then, after the cooking, the titanium plate can be taken out from the cooking oil and put into another heat-cooking vessel. With this titanium plate, it was observed that the cooking oils were extremely cleaned by the method not relying on the direct coating on the fryer inner case.

Further, the present invention provides a cooking-oil degradation prevention method in which a titanium plate including a titanium oxide coating obtained by anodizing a titanium steel cleans a cooking oil at a high temperature while being in contact with the cooking oil.

This cooking oil is not particularly limited, but may include one or more kinds of cooking oils selected from, for example, a vegetable oil selected from a soybean oil, a rape oil, a palm oil, a cotton seed oil, a cacao oil, a sunflower oil, a corn oil, a rice oil and a safflower oil; an animal oil selected from a lard oil and a beef tallow oil; a sardine oil; and a whale oil.

In addition, the titanium oxide coating obtained by anodizing a titanium steel according to the present invention can be manufactured in a method of manufacturing an anatase titanium oxide coating including the following steps:

(i) the step of forming a titanium nitride in a surface of titanium or a titanium alloy; and

(ii) the step of immersing the titanium or titanium alloy obtained in the step (i) in an electrolytic solution containing at least one kind of acid selected from the group consisting of inorganic acids having etching effects on titanium and organic acids having the effects, and anodizing the titanium or titanium alloy with application of a voltage equal to or higher than a sparkover voltage.

With this manufacturing method, a titanium plate including a titanium oxide coating obtained by anodizing a titanium steel is formed as a small piece independent of a heat-cooking vessel. The titanium plate thus formed can be put inside a heat-cooking vessel during cooking irrespective of the type, shape and size of the heat-cooking vessel, and thereby can come into contact with the cooking oil in the heat-cooking vessel. Hence, the titanium plate can come into contact with the cooking oil exposed to a high temperature during the cooking, and then, after the cooking, can be taken out from the heat-cooking vessel and be put and used in another heat-cooking vessel.

Next, description is provided based on experimental examples for the fact that a titanium plate including a titanium oxide coating obtained by anodizing a titanium steel causes excellent actions and effects for degradation prevention of a cooking oil.

Here, the titanium plates used in the following experimental examples were plates manufactured and sold by Sho-wa Co. Ltd., and the component part was qualified to secure the safety and confirmed as being in conformity with the standards and criteria for food by Japan Food Research Laboratories (Certificates of Analysis Nos. 10003923001-02, 10003923001-03, and 10003923001-04).

### Experimental Example 1

### Heating Test

A titanium plate (surface area S=50 cm²) including a titanium oxide coating obtained by anodizing a titanium steel manufactured and sold by Sho-wa Co. Ltd. was used as a cooking-oil degradation prevention material.

A frying pot having a diameter of 225 mm and a height of 75 mm (surface area: approximately 400 cm²) was used, 250 grams of a cooking oil (fresh soybean oil) and the above titanium plate were put into the pot, and then a long-term degradation test was conducted at an oil temperature of 200° C. for 30 consecutive hours.

In this test, the amount of oil in contact with air was approximately 0.625 g/cm² and the amount of oil in contact with the titanium plate was 5 g/cm².

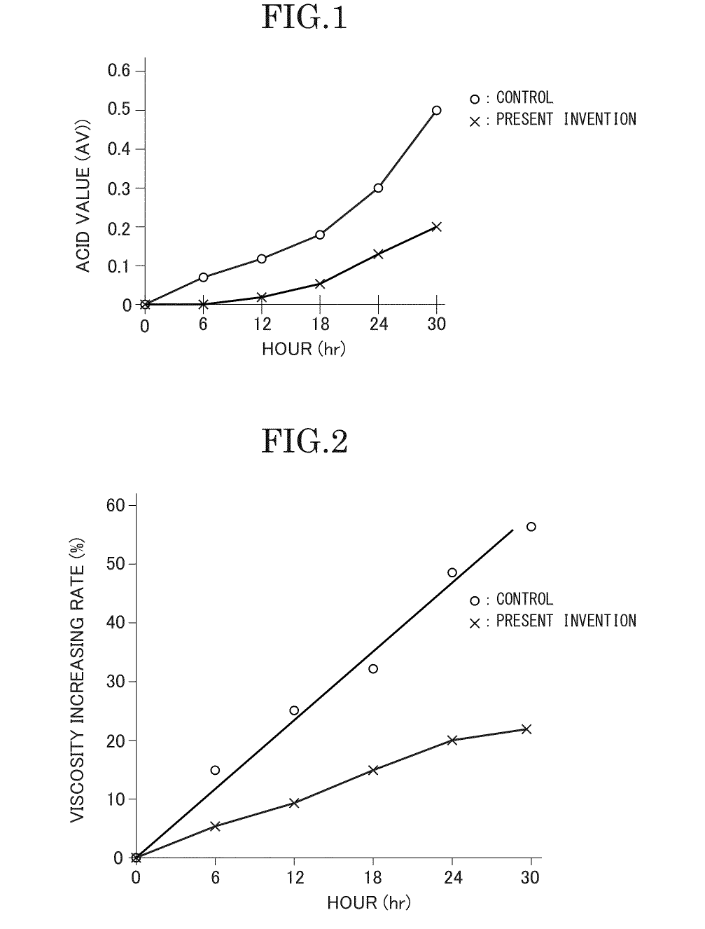

FIG. 1 and FIG. 2 show the result in comparison with a control or contrast of a case where no titanium plate was put. Here, the acid value was measured at predetermined time intervals at a room temperature (25° C.) by the KOH method and is expressed as a difference from a reference value.

Moreover, for a viscosity increase shown therein, the viscosity was measured at predetermined time intervals with a Cannon-Fenske viscosity meter being set in a thermobath adjusted at 50° C., and was converted into an increasing rate (viscosity increasing rate).

As shown in FIG. 1, the blank sample as the control had a high acid value of 0.50 after 30 hours, whereas the experimental example where the titanium plate was put had a suppressed acid value of 0.20 after 30 hours.

In addition, as shown in FIG. 2, the blank sample as the control had a high viscosity increasing rate of 55% after 30 hours, whereas the experimental example where the titanium plate was put had a suppressed viscosity increasing rate of 23% after 30 hours.

### Experimental Example 2

### Frying Test

An experiment was conducted by actually deep-frying potatoes in a fryer in Experimental Example 1.

The experiment was made in which potatoes of an approximately 30 mm square with a thickness 5 mm were coated with a batter being a mixture of a wheat flour and water and then were deep-fried.

As experimental conditions, the oil temperature was kept at 200° C., a deep-frying duration for one time was set to 5 minutes, and a sample oil at 10 g was taken after one hour, then, a new potato coated with the batter was put and deep-fried for 5 minutes in the same manner, and then the sample oil was taken after two hours. The above procedure was taken six times (six hours) in total.

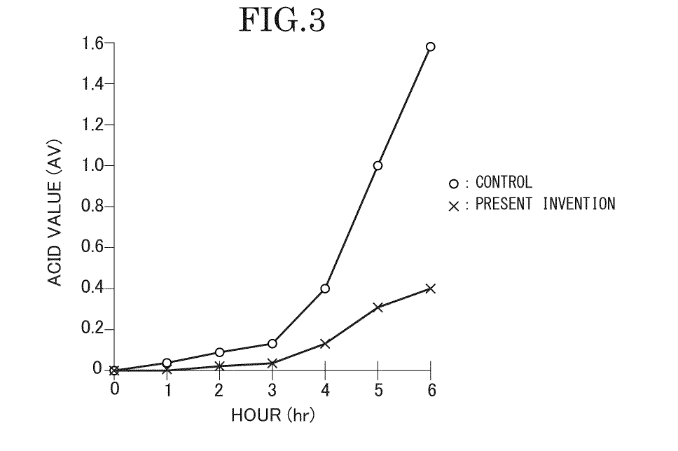

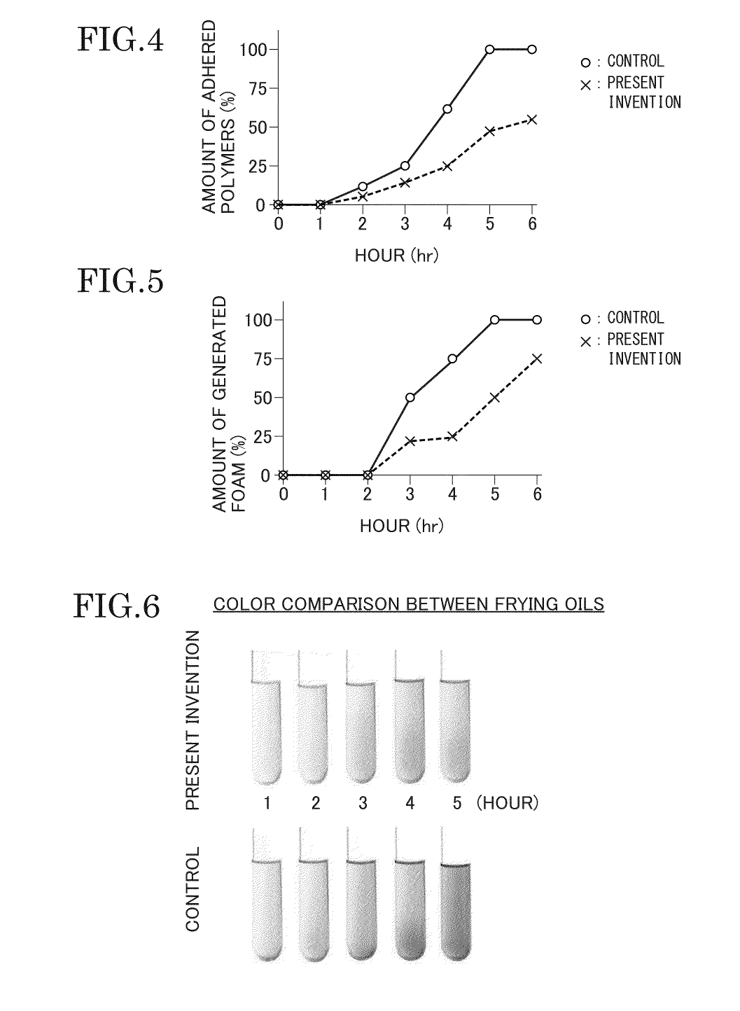

As compared with a control example, the acid value, the amount of adhered polymers, the amount of generated foam, and the degree of coloration were evaluated and are shown in FIG. 3 to FIG. 5.

The acid value measurement: the measurement was made in the same manner as in Experimental Example 1.

The amount of adhered polymers: the amount of adhered polymers generated around a boundary between air and the cooking oil on a fryer inner surface was judged as to its level in comparison with that of the control, and is expressed as the judgment result.

The amount of generated foam of the cooking oil: the degree at which generated foam occupied the entire surface of the cooking oil one and half minutes after the potato was put in the fryer is shown in a comparative manner.

### Experimental Example 3

### Frying Test, Color Comparison between Frying Oils

An experiment was conducted by actually deep-frying potatoes in a fryer in Experimental Example 1.

The experiment was made in which potatoes of an approximately 30 mm square with a thickness 5 mm were coated with a batter being a mixture of a wheat flour and water and then were deep-fried.

As experimental conditions, the oil temperature was kept at 200° C., a deep-frying duration for one time was set to 5 minutes, and a sample oil at 10 g was taken after one hour, then, a new potato coated with the batter was put and deep-fried for 5 minutes in the same manner, and then the sample oil was taken after two hours. The above procedure was taken five times (five hours) in total.

In comparison with a control example, the degrees of coloration are shown in FIG. 6 as color comparisons between the frying oils.

The colored frying oil with the titanium plate put therein (product of the present invention) even after five hours was clearer and cleaner than the frying oil colored after three hours in a control example as a blank sample.

### Experimental Example 4

### Test Using Real Fryer

A pot (fryer) of 20 liters was used.

Moreover, two titanium plates (5 cm×10 cm) (total area 200 cm²) were used as the titanium plate and a soybean oil was used as the oil. Tonkatsu, i.e., pork cutlets were deep-fried at an oil temperature of 180° C.

For a sensory test, five males (at the ages of 15, 20, 30, 45, and 67) and five females (at the ages of 18, 23, 32, 43, and 66) were asked to be testers for making seven-grade evaluation with ±3 grades. Then, all the obtained test results indicate that the cutlets were better than those in blank samples as the control.

A single male scoring a plus-one grade rated the cutlet as having brittle and crispy textures.

Three males and three females scoring a plus-two grade generally rated the cutlets as having a brittle texture and a crispy texture apparently. A single male and two females scoring a plus-three grade rated the cutlets as having a strong crispy texture and crunchy texture.

As a result, 9 testers out of the 10 male and female testers judged the cutlets as better.

Similarly, the non-greasiness as a food texture was also evaluated. Then, two males and three females scored a plus-one grade in which the cutlets were rated as non-greasy and two males and three females scored a plus-two grade in which the cutlets were rated as non-greasy apparently.

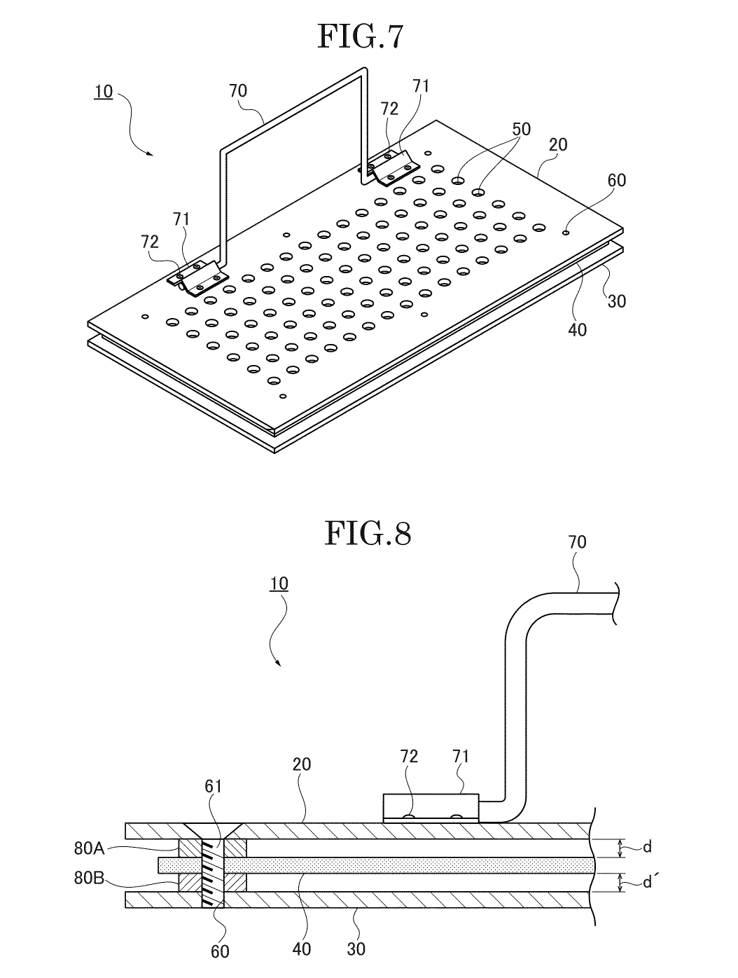

FIG. 7 illustrates another example of the cooking-oil degradation preventer according to the present invention.

In this other example, a cooking-oil degradation preventer 10 includes a pair of upper and lower protection plates (protection members) 20, 30 and a titanium plate 40 interposed between the protection plates 20, 30.

This titanium plate 40 includes, for example, a titanium oxide coating obtained by anodizing a titanium steel.

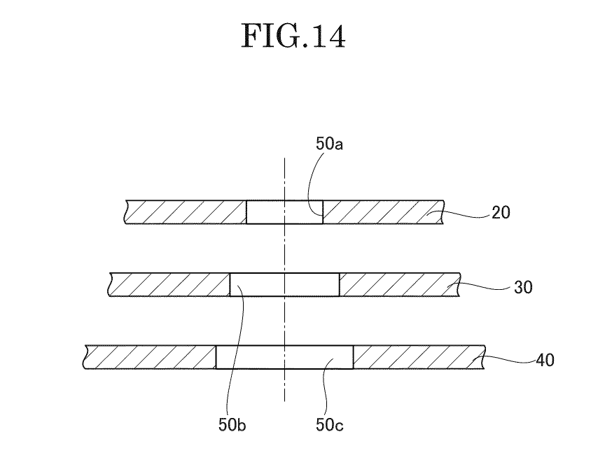

In this cooking-oil degradation preventer 10, the protection plates 20, 30 and the titanium plate 40 are provided with multiple openings, more specifically through holes 50 for convecting a cooking oil and falling down impure substances, for example, pieces of a tempura batter in the cooking oil. The titanium plate 40 includes the titanium oxide coating obtained by anodizing the titanium steel. Note that, as shown in FIG. 14, through holes 50a provided in the protection plate 20, through holes 50c provided in the titanium plate 40, and through holes 50b provided in the protection plate 30 are set such that the through holes 50a have the smallest diameter, the through holes 50b have an intermediate diameter, and the through holes 50c have the largest diameter. With this configuration, tempura scraps and the like more easily pass through these through holes from above to below the cooking-oil degradation preventer.

The titanium oxide coating can be manufactured with a method of manufacturing an anatase titanium oxide coating including the following steps:

(i) forming a titanium nitride in a surface of titanium or a titanium alloy; and (ii) immersing the titanium or titanium alloy obtained in the step (i) in an electrolytic solution containing at least one kind of acid selected from the group consisting of inorganic acids having etching effects on titanium and organic acids having the effects, and anodizing the titanium or titanium alloy with application of a voltage equal to or higher than a sparkover voltage.

This titanium plate 40 is a flat plate usually having a thickness within a range of 0.1 mm to 5 mm, and preferably on the order of 0.3 to 2 mm, but the thickness is not limited to the above. In addition, the shape of the titanium plate 40 is generally a flat plate shape, but may be any shape such as a lath, net, or pipe shape without limitation to the flat plate. The titanium plate 40 may be subjected to an appropriate machining process such as a bending process or cutting process. Such machining process may be performed before or after the titanium oxide coating is provided. Moreover, a welding work may be performed after the titanium oxide coating is provided.

In this example, this titanium plate 40 is used as a small piece. When being used as a small piece, the titanium plate 40 can be put into a cooking oil during cooking irrespective of the type, shape and size of a heat-cooking vessel, and thereby can come into contact with the cooking oil exposed to a high temperature during the cooking. Then, after the cooking, the titanium plate can be taken out from the cooking oil and put into another heat-cooking vessel. With this titanium plate, the cooking oils can be prevented from degrading by the method not relying on the direct coating on the fryer inner case.

The small piece of the titanium plate for business use has a size of 50 cm×50 cm or smaller, and preferably 30 cm×30 cm or smaller, for example. In contrast, the size for home use is 20 cm×20 cm or smaller, or may be 10 cm×20 cm or smaller.

Here, this titanium plate 40 includes the anatase titanium oxide coating, and the catalytic activity of the anatase titanium oxide coating can be repeatedly utilized even when its surface is yellowed to some extent, as long as the coating can come into contact with a cooking oil at a high temperature. Moreover, in this example, a main surface as a catalytic surface is protected by the protection members such as the protection plates 20, 30. Hence, a person who prepares foods does not directly see the titanium plate, and thereby can use the titanium plate without caring about yellow discoloration. Thus, the product value as a cooking-oil degradation prevention material can be enhanced.

Here, in FIG. 7 illustrating this example, stainless punching metal sheets with a sheet thickness of 0.8 mm are used as the protection plates 20, 30. The shapes and sizes of holes formed in the protection plates 20, 30 are not particularly limited, but may be any as long as they can secure an internal protection function and passing properties of a cooking oil. Here, in this example, a titanium plate having a length of 230 mm is punched with about 15 holes 50 having a diameter of 6 mm in each row at equal intervals in both longitudinal and crosswise directions while leaving a margin for screwing (or a margin for pinning) in the periphery of the titanium plate.

In this example, the margin for screwing (or the margin for pinning) is provided with screwing holes (or pinning holes) 60 at six positions including four corners and center positions in the long sides.

By use of these screwing holes (or pinning holes) 60, the titanium plate 40 is fixed with screws (or pins) 61 at certain distances d, d′ from the protection plate 20 and the protection plate 30 in the cooking-oil degradation preventer 10 according to this example. In an example illustrated in FIG. 8, since the titanium plate 40 is fixed by using a pair of upper and lower ring-shaped spacers 80A, 80B, the distance d and the distance d′ are equal to each other. The distances, however, may be different from each other.

Materials for these screws (or pins) 61 or ring-shaped spacers (or collars) 80A, 80B are not particularly limited, and this example employs a stainless material having the same properties as the protection members or the protection plates 20, 30, for example.

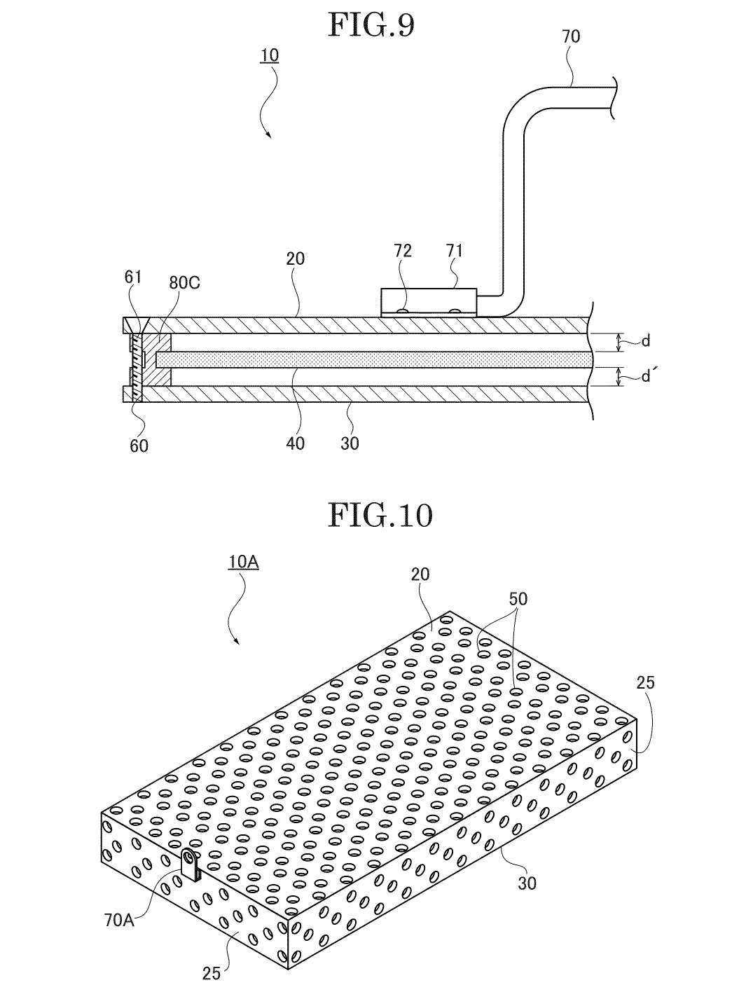

Here, the distances d, d′ can be secured by using a rail instead of the spacers 80A, 80B. In a modified example illustrated in FIG. 9, a rail 80C is fixed between short side edges of the protection plates 20, 30 with screws 61, in place of (or in addition to) the fixation illustrated in FIG. 8. The titanium plate 40 is slid on and guided by the rail 80C and thereby is placed between the upper and lower protection plates 20, 30. The titanium plate 40 may be fixed with a pin as needed.

Here, in the cooking-oil degradation preventer 10 according to the example and the modified example described above, a foldable upright handle 70 is provided on a surface of the protection plate 20. This handle 70 is fixed to the protection plate 20 with metallic parts 71 fixed with screws 72 as shown in FIG. 7 to FIG. 9.

As described above, inside the protection members through which the cooking oil can flow into their inside, the titanium plate including the titanium oxide coating obtained by anodizing the titanium steel is placed away from the inner surfaces of the protection members so that most of the front and back surfaces of the titanium plate can come into contact with a cooking oil during cooking.

Here, the protection members are unnecessary in essentials for the purpose of preventing degradation of a cooking oil. However, the titanium plate is changed in color from white to yellow by being in contact with the cooking oil at a high temperature, and therefore may bring an unpleasant feeling to a person who cooks foods. When the titanium plate is protected between the protection members through which the cooking oil can flow into their inside, the protection members prevent the person preparing foods from noticing the yellow discoloration of the titanium plate without blocking the contact between the surfaces of the titanium plate and the cooking oil at a high temperature.

These protection members can be formed from stainless punching metal sheets, for example. The protection members made of stainless sheets have high durability, and the protection members made of punching metal sheets allow a cooking oil during cooking to favorably flow into between the protection members and exert excellent drainage properties of the cooking oil when taken out from the cooking oil after cooking.

In addition, the titanium plate is preferably configured to be detachable from the protection members. When the titanium plate is configured to be detachable by using a method such as screwing without welding, the titanium plate can be easily taken out from the protection members, cleaned and then assembled again when the surface of the titanium plate becomes dirty due to the adhesion of deposits or even has heavy yellow discoloration.

Next, description is provided for use conditions of the cooking-oil degradation preventer 10 configured as described above.

In the cooking-oil degradation preventer 10, the protection plate 20 and the protection plate 30 are both formed from the punching metal sheets, and are arranged with the front and back surfaces of the titanium plate 40 spaced out at distances d, d′ from the inner surfaces of the protection plates 20, 30 with the function of spacers 80A, 80B or the rail 80C, so that a cooking oil can flow into between the protection plates 20, 30.

A cooking oil during cooking always convects in up-and-down directions with heating from below the cooking vessel and heat-dissipation from the surface, and therefore also always convects between the protection plates 20, 30 including the multiple holes 50. Thus, most of the front and back surfaces of the titanium plate 40 can be always in contact with the cooking oil at a high temperature during cooking, and harmful substances in the cooking oil are decomposed under the thermal catalyst action of the anatase titanium oxide catalyst.

When foods such as a fry are prepared under the above conditions, deep-fried foods such as a fry with non-greasy texture and crispy texture can be always cooked due to suppression of oil degradation, less polymerization and excellence in oil drainage.

Moreover, this also enables significant reduction in waste oil and also lessens lampblack formation and smell, so that cooking oil consumption per month can be saved (for example, about 40% of saving).

After cooking, the cooking-oil degradation preventer can be taken out from the cooking oil with the handle 70 lifted up by frying tongs or the like, and then can be put and used in another cooking oil.

The titanium oxide coating is discolored yellow when being in contact with cooking oil at a high temperature. However, the cooking-oil degradation preventer can be used without its yellow discoloration noticed because the coating is protected by the protection plates 20, 30 as the protection members.

In addition, when the soil including the yellow discoloration is thought to be a problem, the cooking-oil degradation preventer can be cleaned by being soaked for a while and then washed in a mixture of an alkaline agent (for example, caustic soda or the like) and a neutral detergent. Thus, the maintenance is easy. When stubborn soil is stuck to the protection plates 20, 30, the handle 70, or the like, the cooking-oil degradation preventer can be also washed after being disassembled as a whole by unscrewing the screwed portions.

Furthermore, the titanium plate 40 can be replaced with a new one, or cleaning of the titanium plate 40 can be requested to its manufacturer. As in quite common practice in the sales of water purifiers, a service may be provided which encourages a replacement of the titanium plate 40 after use for a certain period of time, or on a regular basis. In this case, the replacement service providers can recover and reuse the titanium plates by washing with expertise.

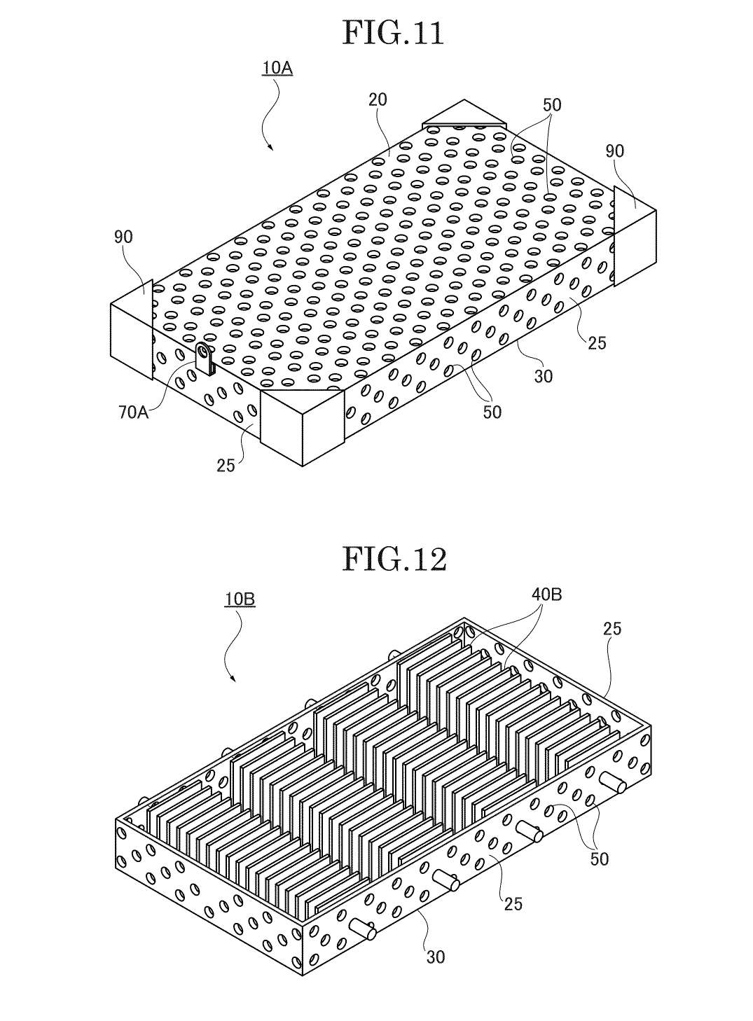

Next, a cooking-oil degradation preventer 10A as a modified example is described with reference to FIG. 10 and FIG. 11.

In this modified example, this cooking oil prevention tool 10A includes a protection member shaped like a cuboid container in which the upper and lower sides are protected by protection plates 20, 30 and additionally the side surfaces are protected by protection plates 25. All of the protection plates 20, 25, 30 are formed from perforated plates including multiple openings, i.e., through holes 50 in the whole surfaces, and are all made of a ceramic material, for example.

An example illustrated in FIG. 11 is an example in which reinforcements are provided to corners, and edge reinforcement corner members 90 are provided to the four corner portions, respectively.

In the cooking-oil degradation preventers 10A according to these modified examples, a small fixed hooked portion 70A is provided in place of the handle 70 in the cooking-oil degradation preventer 10.

In these configurations, the whole protection member is made of the ceramic material, so that the protection member is light-weighted and will never rust.

The small hooked portion 70A provided on a shorter side is a hooked portion for storage using a hook provided on a shelf or the like. This hooked portion 70A can be also used to take out the cooking-oil degradation preventer 10A. Instead, as a matter of course, the multiple openings or holes 50 provided in the whole surfaces may be used to take out the cooking-oil degradation preventer 10A from a cooking oil.

Here, the shape and the like of a titanium protection plate 40 inside these cooking-oil degradation preventers 10A may be substantially the same as those in the cooking-oil degradation preventer 10.

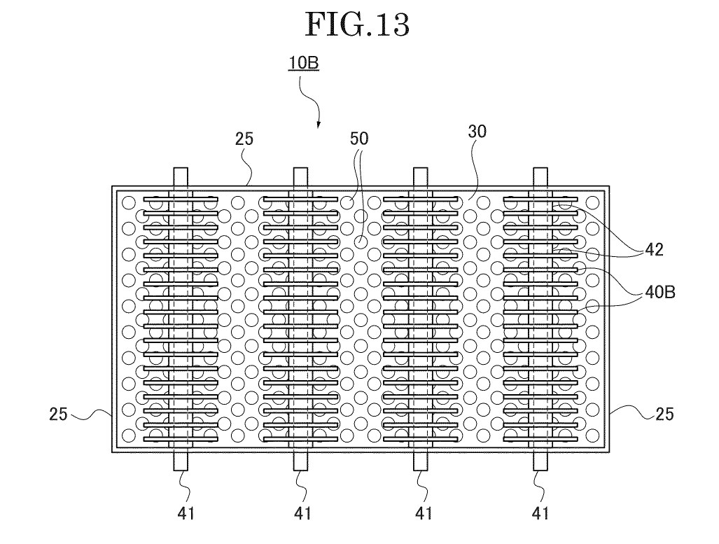

Next, a cooking-oil degradation preventer 10B as another modified example is described with reference to FIG. 12 and FIG. 13.

In the cooking-oil degradation preventer 10B according to this modified example, many rods 41 are fixed between protection plates 25, 25 located at side surfaces on the long sides, while passing through the protection plates 25, 25, as illustrated in FIG. 12 or FIG. 13. Many titanium plates 40B are fixed to each rod 41 in a skewered manner (tandem state) with spacers (collars) 42 interposed in between. Thereby, the titanium plates 40B are set to be substantially parallel to the protection plates 25.

In this configuration, the titanium plates 40B are formed as multiple small pieces, and the small pieces are arranged in tandem, so that a large contact area with a cooking oil can be secured. When the cooking-oil degradation preventer 10B as described above is put inside a fryer with the protection plate 30 located on a lower side of the cooking oil (that is, the protection plate 20 located on the surface side of the cooking oil), the cooking oil during cooking can smoothly convect with the function of the spacers (collars) 42. Hence, the effects of the present invention can be achieved more efficiently. Here, the spacers (collars) become unnecessary if the titanium plates 40B and the rod 41 are welded by spot welding.

Needless to say, appropriate design change can be made for the purpose of securing the contact area with a cooking oil and making smooth convection. As one example thereof, the arrangement of the titanium plates 40B illustrated in FIG. 12 may be changed to a zigzag arrangement in a plan view.

Instead, since the titanium plate including the anatase titanium oxide coating described in Patent Document 3 can be processed in a state including the anatase titanium oxide coating, the titanium plate may employ a bellows-like folded structure or a scroll structure, for example. In any of the structures, it is preferable that the titanium plates be parallel to the protection plates at the side surfaces (the main surfaces of the titanium plates during cooking are arranged along a vertical direction), because the sufficient convection can be secured.

Here, a wide range of cooking oils applicable as edible oil can be used as a cooking oil to which the present invention can be applied. These may include one or more kinds of cooking oils selected from, for example, a vegetable oil selected from a soybean oil, a rape oil, a palm oil, a cotton seed oil, a cacao oil, a sunflower oil, a corn oil, a rice oil and a safflower oil; an animal oil selected from a lard oil and a beef tallow oil; a sardine oil; and a whale oil.

As described above, the titanium plate including the titanium oxide coating obtained by anodizing the titanium steel (cooking-oil degradation prevention material) according to the present invention is brought into contact with a cooking oil during cooking. This contact enables suppression of an increase in the acid value, coloration prevention, suppression of bad smelling, and suppression of an increase in the viscosity for a cooking oil. In addition, the contact of the cooking-oil degradation prevention material according to the present invention with the cooking oil during cooking enhances crunchy and brittle textures of a fry cooked by deep-frying in a food texture test.

Moreover, this cooking-oil degradation prevention material is formed as a body independent of a heat-cooking vessel, and therefore can be used in multiple heat-cooking vessels irrespective of the types, kinds and sizes of the vessels.

In addition, since the function of the cooking-oil degradation prevention material is produced by the catalytic action, the catalyst itself is not consumed. Thus, the catalyst surfaces are exposed by washing the surfaces, and the catalyst can be repeatedly used.

Although the preferred examples of the present invention have been described above, it should be understood that the present invention is not limited to the above examples, but these examples can be modified and altered in various ways.

### INDUSTRIAL APPLICABILITY

As described above, according to the present invention, a titanium plate including a titanium oxide coating obtained by anodizing a titanium steel is formed as a small piece independent of a heat-cooking vessel. The titanium plate thus formed can be placed inside a heat-cooking vessel during cooking irrespective of the type, shape and size of the heat-cooking vessel, and thereby can come into contact with the cooking oil in the heat-cooking vessel. Hence, the titanium plate can come into contact with the cooking oil exposed to a high temperature during the cooking, and then, after the cooking, can be taken out from the heat-cooking vessel and be put and used in another heat-cooking vessel.

In addition, the cooking-oil degradation prevention material according to the present invention is brought into contact with a cooking oil at a high temperature during cooking, and this contact enables suppression of an increase in the acid value, coloration prevention, suppression of bad smelling, and suppression of an increase in the viscosity for a cooking oil. Moreover, the contact of the cooking-oil degradation prevention material according to the present invention with the cooking oil during cooking enhances crunchy and brittle textures of a fry cooked by deep-frying in a food texture test.

Further, this cooking-oil degradation prevention material is formed as a body independent of a heat-cooking vessel, and therefore can be used in multiple heat-cooking vessels irrespective of the types, kinds and sizes of the vessels.

Furthermore, since the function of the cooking-oil degradation prevention material is produced by the catalytic action, the catalyst itself is not consumed. Thus, the catalyst surfaces are exposed by washing the surfaces, and the catalyst can be repeatedly used.

1. A cooking-oil degradation preventer characterized in that
the cooking-oil degradation preventer comprises a titanium plate to be accommodated in a pot, and
the titanium plate is positioned to be in contact with a cooking oil filled in the pot, and includes a titanium oxide coating obtained by anodizing a titanium steel.

2. The cooking-oil degradation preventer according to claim 1, characterized in that
the titanium plate includes a plurality of openings provided to pass through the titanium plate in its thickness direction, and configured to allow scraps in the cooking oil to pass therethrough during cooking.

3. A cooking-oil degradation preventer characterized in that a titanium plate including a titanium oxide coating obtained by anodizing a titanium steel is arranged in a protection member through which a cooking oil is allowed to flow into an inner space of the protection member, in such a manner that most of front and back surfaces of the titanium plate is spaced out from an inner surface of the protection member so as to be able to come into contact with a cooking oil during cooking.

4. The cooking-oil degradation preventer according to claim 3, characterized in that
the protection member is formed from a stainless punching metal sheet.

5. The cooking-oil degradation preventer according to claim 3, characterized in that the titanium plate is configured to be detachable from the protection member.

6. A cooking-oil degradation prevention method characterized in that the method comprises preventing degradation of a cooking oil at a high temperature in such a way that a titanium plate including a titanium oxide coating obtained by anodizing a titanium steel is kept in contact with the cooking oil.

7. The cooking-oil degradation prevention method according to claim 6, characterized in that
the cooking oil includes one or more kinds of cooking oils selected from a vegetable oil selected from a soybean oil, a rape oil, a palm oil, a cotton seed oil, a cacao oil, a sunflower oil, a corn oil, a rice oil and a safflower oil; an animal oil selected from a lard oil and a beef tallow oil; a sardine oil; and a whale oil.

8. The cooking-oil degradation preventer according to claim 1, characterized in that
the titanium oxide coating obtained by anodizing the titanium steel is manufactured with a method of manufacturing an anatase titanium oxide coating including the following steps of:
(i) forming a titanium nitride in a surface of titanium or a titanium alloy; and
(ii) immersing the titanium or titanium alloy obtained in the step (i) in an electrolytic solution containing at least one kind of acid selected from the group consisting of inorganic acids having etching effects on titanium and organic acids having the effects, and anodizing the titanium or titanium alloy with application of a voltage equal to or higher than a sparkover voltage.

9. The cooking-oil degradation preventer according to claim 3, characterized in that
the titanium oxide coating obtained by anodizing the titanium steel is manufactured with a method of manufacturing an anatase titanium oxide coating including the following steps of:
(i) forming a titanium nitride in a surface of titanium or a titanium alloy; and
(ii) immersing the titanium or titanium alloy obtained in the step (i) in an electrolytic solution containing at least one kind of acid selected from the group consisting of inorganic acids having etching effects on titanium and organic acids having the effects, and anodizing the titanium or titanium alloy with application of a voltage equal to or higher than a sparkover voltage.
